(19) United States
(12) Patent Application Publication
(10) Pub. No.: US 2024/0396375 A1
(43) Pub. Date: Nov. 28, 2024

(54) WIRELESS POWER RECEIVING DEVICE

(71) Applicant: Murata Manufacturing Co., Ltd., Kyoto-fu (JP)

(72) Inventors: Takahiro NAGAI, Nagaokakyo-shi (JP); Tatsuya HOSOTANI, Nagaokakyo-shi (JP)

(73) Assignee: Murata Manufacturing Co., Ltd., Kyoto-fu (JP)

(21) Appl. No.: 18/792,853

(22) Filed: Aug. 2, 2024

Related U.S. Application Data
(63) Continuation of application No. PCT/JP2023/002339, filed on Jan. 26, 2023.

(30) Foreign Application Priority Data
Feb. 3, 2022 (JP) 2022-015309

(51) Int. Cl. H02J 50/12; H02H 9/04; H02J 50/80

(52) U.S. Cl. CPC H02J 50/12; H02H 9/04; H02J 50/80

(57) ABSTRACT

A wireless power receiving device includes a receiving power shut-off circuit and an impedance adjusting circuit. When a smoothed voltage is less than a first voltage, the receiving power shut-off circuit causes a rectifying circuit to execute a rectifying operation. When the smoothed voltage is greater than or equal to the first voltage, the receiving power shut-off circuit causes the rectifying circuit to stop the rectifying operation and by stopping the rectifying operation of the rectifying circuit, protects a power receiving direct-current circuit from overvoltage. The impedance adjusting circuit suppresses an increase in a voltage between two ends of a power receiving coil and further protects a power receiving alternating-current circuit from overvoltage at the time of both executing and stopping the rectifying operation caused by the receiving power shut-off circuit. Thus, the impedance adjusting circuit protects both the power receiving alternating-current circuit and the power receiving direct-current circuit.

### CROSS-REFERENCE TO RELATED APPLICATIONS

This application claims benefit of priority to International Patent Application No. PCT/JP2023/002339, filed Jan. 26, 2023, and to Japanese Patent Application No. 2022-015309, filed Feb. 3, 2022, the entire contents of each are incorporated herein by reference.

### BACKGROUND

### Technical Field

The present disclosure relates to a wireless power receiving device that receives power using electromagnetic coupling or electromagnetic resonance coupling.

### Background Art

In existing wireless power transfer systems, various techniques are devised for controlling the receiving power voltage on the power receiving device side.

In Japanese Unexamined Patent Application Publication No. 2020-178442, a synchronous rectification controller performs switching control to adjust a rectified voltage to be output to a load. In Japanese Unexamined Patent Application Publication No. 2020-150699, a power storage element is used to process received excess power. In Japanese Unexamined Patent Application Publication No. 2020-120434, a resonance suppressing coil is used to suppress an excessive increase in the output voltage of a power receiving device.

In Japanese Unexamined Patent Application Publication No. 2020-072604, a sub-coil on the power receiving side is used to suppress an excessive increase in voltage that occurs in a power receiving resonant circuit. In Japanese Unexamined Patent Application Publication No. 2019-071705, the receiving power voltage is adjusted using a Q factor matching circuit that matches a Q factor of a power receiving coil appropriately. In Japanese Patent No. 6890379 Specification, an overvoltage protection circuit including a switch that is connected in series to a capacitor is used for overvoltage protection.

In Japanese Patent No. 6427983 Specification, protection against overcurrent and overvoltage is achieved using a resonance modulation circuit. In Japanese Patent No. 6252334 Specification, a power receiving side resonant circuit is protected by controlling a power receiving side filter having a reactor. In Japanese Patent No. 6379660 Specification, a receiving power shut-off circuit is used for overvoltage protection. In Japanese Patent No. 5998905 Specification, a clamping circuit is included in a subsequent stage of a rectifying circuit, and the clamping circuit controls voltage.

### SUMMARY

However, in the existing configurations described above, it is difficult to maintain appropriate operation even when there is a change in the strength of an external magnetic field that couples with a power receiving coil and protect an alternating-current circuit and a direct-current circuit when the external magnetic field increases excessively.

Accordingly, the present disclosure provides a wireless power receiving device that can continue the appropriate operation by suppressing an effect caused by a change in the external magnetic field and protect a power receiving alternating-current circuit and a power receiving direct-current circuit.

A wireless power receiving device that is one aspect of this disclosure includes a power receiving circuit, a load circuit, and a power receiving coil. The load circuit is electrically connected to the power receiving circuit. The power receiving coil is electrically connected to the power receiving circuit.

The power receiving circuit includes an impedance adjusting circuit, a rectifying circuit, a smoothing circuit, and a receiving power shut-off circuit. The impedance adjusting circuit adjusts input impedance looking from the power receiving coil into the load circuit side. The rectifying circuit rectifies an alternating-current current flowing through the power receiving coil. The smoothing circuit is electrically connected to the rectifying circuit. The receiving power shut-off circuit switches between executing and stopping a rectifying operation of the rectifying circuit using a result of comparison between a smoothed voltage of the smoothing circuit and a predetermined first voltage.

The power receiving coil, the impedance adjusting circuit, and the rectifying circuit constitute a power receiving alternating-current circuit. The smoothing circuit and the load circuit constitute a power receiving direct-current circuit.

The first voltage is set on the basis of the size of an external magnetic field that acts on the power receiving coil and the size of power of the load circuit. The impedance adjusting circuit suppresses an increase in the output voltage of the power receiving coil.

When the smoothed voltage is less than the first voltage, the receiving power shut-off circuit causes the rectifying circuit to execute a rectifying operation. When the smoothed voltage is greater than or equal to the first voltage, the receiving power shut-off circuit causes the rectifying circuit to stop the rectifying operation, and by using the impedance adjusting circuit and the receiving power shut-off circuit, the power receiving alternating-current circuit and the power receiving direct-current circuit are protected from overvoltage.

With this configuration, when a voltage greater than or equal to the first voltage is applied to the power receiving direct-current circuit due to the external magnetic field, the power receiving direct-current circuit is protected from overvoltage by the receiving power shut-off circuit. Further, the voltage between two ends of the power receiving coil is suppressed by the impedance adjusting circuit, and thus, regardless of the operation status of the receiving power shut-off circuit, the power receiving alternating-current circuit and the power receiving direct-current circuit are protected.

According to this disclosure, it becomes possible to protect the power receiving direct-current circuit from overvoltage using the receiving power shut-off circuit, and further, regardless of the operation status of the receiving power shut-off circuit, it becomes possible to protect the power receiving alternating-current circuit and the power receiving direct-current circuit using the impedance adjusting circuit.

### BRIEF DESCRIPTION OF THE DRAWINGS

FIG. 1 is a circuit diagram illustrating a configuration of a wireless power receiving device according to a first embodiment;

FIG. 2 is a functional block diagram illustrating an example of a power transmitting device according to the present embodiment;

FIG. 3A is a diagram illustrating an exemplary displacement of external magnetic field strength in a configuration of the present application, and FIG. 3B is a diagram illustrating an exemplary displacement of external magnetic field strength in a comparative configuration (configuration in which an impedance adjusting circuit of the configuration of the present application is not included);

FIG. 4 is a circuit diagram illustrating an example of configuration of a wireless power receiving device according to a second embodiment;

FIG. 5 is a circuit diagram illustrating an example of configuration of a wireless power receiving device according to a third embodiment;

FIG. 6 is a circuit diagram illustrating an example of configuration of a wireless power receiving device according to a fourth embodiment; and

FIG. 7 is a circuit diagram illustrating an example of configuration of a wireless power receiving device according to a fifth embodiment.

### DETAILED DESCRIPTION

### First Embodiment

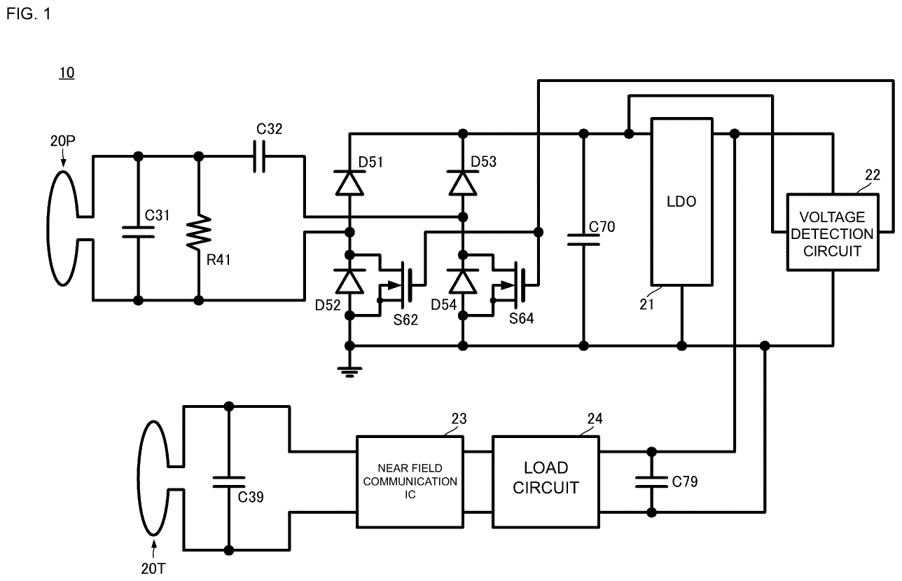

A wireless power receiving device according to the first embodiment of the present disclosure is now described with reference to the drawings. FIG. 1 is a circuit diagram illustrating an example of configuration of the wireless power receiving device according to the first embodiment.

As illustrated in FIG. 1, a wireless power receiving device 10 includes a power receiving coil 20P, a communication antenna 20T, a capacitor C31, a capacitor C32, a resistive element R41, a diode D51, a diode D52, a diode D53, a diode D54, a switching element S62, a switching element S64, a capacitor C70, a capacitor C79, a LDO 21, a voltage detection circuit 22, a near field communication IC 23, and a load circuit 24.

### (Power Receiving Coil, Power Receiving Resonant Circuit, and Impedance Adjusting Circuit)

The power receiving coil 20P is, for example, a loop coil. The capacitor C31 is connected at two end portions of the power receiving coil 20P. One terminal of the capacitor C32 is connected to a first end portion of the power receiving coil 20P. The other terminal of the capacitor C32 is connected to a node between the diode D53 and the diode D54. A second end portion of the power receiving coil 20P is connected to a node between the diode D51 and the diode D52.

The power receiving coil 20P, the capacitor C31, and the capacitor C32 constitute a power receiving resonant circuit. A resonant frequency of the power receiving resonant circuit is substantially equal to a resonant frequency of a power transmitting resonant circuit of a power transmitting device 90, which will be described later, and this resonant frequency is a frequency of an external magnetic field. The capacitor C31 corresponds to a “first resonant capacitor” of the present disclosure, and the capacitor C32 corresponds to a “second resonant capacitor” of the present disclosure.

The resistive element R41 is connected at two end portions of the power receiving coil 20P. One end portion of the resistive element R41 is connected at a position closer to the first end portion of the power receiving coil 20P than the capacitor C32. The other end portion of the resistive element R41 is connected to the second end portion of the power receiving coil 20P. By using the resistive element R41, the input impedance looking from the power receiving coil 20P into the load circuit (which will be described later in detail) side is adjusted to a predetermined value. The resistive element R41 correspond to an “impedance adjusting circuit” of the present disclosure.

### Receiving Power

### (Rectifying Circuit, Receiving Power Shut-Off Circuit, and Smoothing Circuit)

The diode D51 and the diode D52 are connected in series. More specifically, the anode of the diode D51 is connected to the cathode of the diode D52. The cathode of the diode D51 is connected to a Hi side wiring pattern, and the anode of the diode D52 is connected to a Low side wiring pattern. The Low side wiring pattern is connected to a reference potential.

The diode D53 and the diode D54 are connected in series. More specifically, the anode of the diode D53 is connected to the cathode of the diode D54. The cathode of the diode D53 is connected to the Hi side wiring pattern, and the anode of the diode D54 is connected to the Low side wiring pattern.

As described above, the node between the anode of the diode D51 and the cathode of the diode D52 is connected to the second end portion of the power receiving coil 20P. As described above, the node between the anode of the diode D53 and the cathode of the diode D54 is connected to the other terminal of the capacitor C32.

The circuit made up of a plurality of the diodes D51 to D54 corresponds to a “rectifying circuit” of the present disclosure. Furthermore, a “power receiving alternating-current circuit” of the present disclosure is made up of the power receiving coil 20P, the impedance adjusting circuit, and the rectifying circuit, which are described in the above, and more specifically, further includes the power receiving resonant circuit.

The switching element S62 is connected in parallel to the diode D52. More specifically, the switching element S62 is made up of, for example, a n-channel FET. The drain of the switching element S62 is connected to the cathode of the diode D52. The source of the switching element S62 is connected to the anode of the diode D52.

The switching element S64 is connected in parallel to the diode D54. More specifically, the switching element S64 is made up of, for example, a n-channel FET. The drain of the switching element S64 is connected to the cathode of the diode D54. The source of the switching element S64 is connected to the anode of the diode D54. Note that it is preferable that the switching element S62 and the switching element S64 have the same characteristics.

The gate of the switching element S62 and the gate of the switching element S64 are connected to an output port of the voltage detection circuit 22. The switching element S62 and the switching element S64 that operate upon receiving an output from the voltage detection circuit 22 correspond to a “receiving power shut-off circuit” of the present disclosure.

The capacitor C70 is connected between the Hi side wiring pattern and the Low side wiring pattern on an output port side of the rectifying circuit. The capacitor C70 corresponds to a “smoothing circuit” of the present disclosure.

### (Subsequent Stage That Follows Smoothing Circuit)

The LDO 21 is a low loss linear regulator and includes an input terminal, an output terminal, and a reference terminal. The input terminal of the LDO 21 is connected to the Hi side wiring pattern. The reference terminal of the LDO 21 is connected to the Low side wiring pattern. The output terminal of the LDO 21 is connected to the voltage detection circuit 22 and the load circuit 24.

The voltage detection circuit 22 includes a Hi side power source terminal, a reference terminal, a detection voltage input terminal, and a control signal output terminal. The Hi side power source terminal of the voltage detection circuit 22 is connected to the output terminal of the LDO 21. A reference terminal of the voltage detection circuit 22 is connected to the Low side wiring pattern.

The detection voltage input terminal of the voltage detection circuit 22 is connected at a position that is subsequent to the smoothing circuit on the input terminal side of the LDO 21 in the Hi side wiring pattern (position whose potential is the same as that of the node of the capacitor C70 in the Hi side wiring pattern). As described above, the control signal output terminal of the voltage detection circuit 22 is connected to the gate of the switching element S62 and the gate of the switching element S64.

Power source terminals of the load circuit 24 are connected to the output terminal of the LDO 21 and the Low side wiring pattern. The capacitor C79 is connected in parallel to the power source terminals of the load circuit 24.

Furthermore, a power receiving direct-current circuit is made up of the smoothing circuit and the load circuit 24, and more specifically, further includes the LDO 21.

### (Circuit Configuration of Communication System)

The communication antenna 20T is, for example, a loop coil. Note that the communication antenna 20T is not limited to the loop coil. The capacitor C39 is connected at two end portions of the communication antenna 20T. The communication antenna 20T and the capacitor C39 constitute a signal receiving resonant circuit.

Two end portions of the communication antenna 20T are connected to the near field communication IC 23. The near field communication IC 23 is, for example, an NFC IC and is connected to the load circuit 24.

### Example of Operation of Wireless Power Receiving Device 10

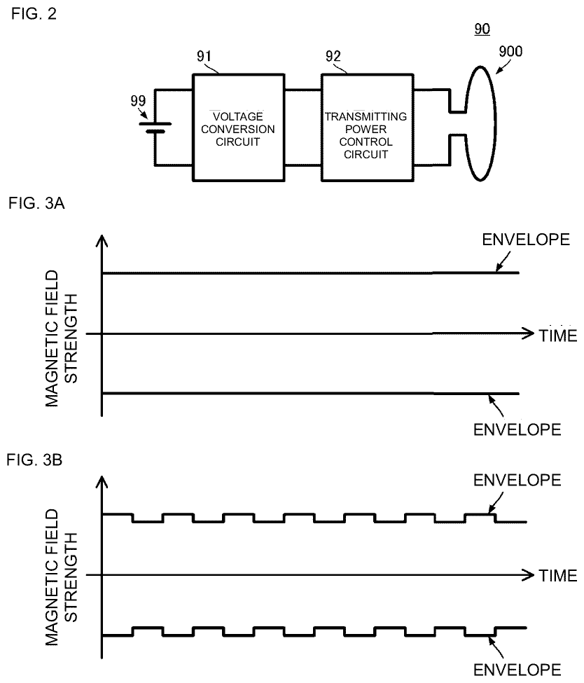

The wireless power receiving device 10 receives power from an external power transmitting device 90 and performs a predetermined operation using the load circuit 24. FIG. 2 is a functional block diagram illustrating an example of the power transmitting device according to the present embodiment.

The power transmitting device 90 includes a voltage conversion circuit 91, a transmitting power control circuit 92, and a power transmitting coil 900. The voltage conversion circuit 91 converts a voltage level of input voltage from an external power source 99 and supplies the resultant voltage to the transmitting power control circuit 92. The transmitting power control circuit 92 converts a direct-current voltage supplied from the voltage conversion circuit 91 into an alternating-current voltage of a predetermined frequency and applies the resultant voltage to the power transmitting coil 900. The power transmitting coil 900 is, for example, a loop coil. By allowing an alternating-current current that corresponds to the applied alternating-current voltage to flow, the power transmitting coil 900 generates an alternating magnetic field.

The wireless power receiving device 10 is arranged in such a way that the power receiving coil 20P couples with the alternating magnetic field generated by the power transmitting coil 900. Because of this, the power receiving coil 20P establishes electromagnetic coupling or electromagnetic resonance coupling with the alternating magnetic field generated by the power transmitting coil 900 and generates an alternating-current current of a predetermined frequency.

In this case, by having the resonant frequency of the power receiving resonant circuit of the wireless power receiving device 10 equal to the frequency of the alternating magnetic field (external magnetic field), it becomes possible to realize a magnetic resonance state using the power receiving coil 20P and the power transmitting coil 900 and enables highly efficient power receiving. Note that this resonant frequency is, for example, 13.56 MHz or 6.78 MHz of ISM band. These resonant frequencies are mere examples, and other frequencies may alternatively be used. However, by using frequencies of ISM band, electromagnetic interference becomes tolerable. Furthermore, by setting the resonant frequency to 6.78 MHz, while tolerating electromagnetic interference, power loss can be reduced, and also it becomes possible to realize the reduction in the size and weight of the wireless power receiving device 10.

The rectifying circuit made up of the plurality of the diodes D51 to D54 rectifies an output current from the power receiving resonant circuit and outputs the resultant current. Because of this, the alternating-current current is converted into the direct-current current. The smoothing circuit smooths the output current and output voltage of the rectifying circuit and outputs the resultant current and voltage to the LDO 21. Because of this, a constant direct-current voltage is supplied to the LDO 21. This output voltage of the smoothing circuit corresponds to “smoothed voltage” of the present disclosure.

The LDO 21 converts an input direct-current voltage (smoothed voltage) into an output direct-current voltage of a desired value and outputs the resultant voltage as a power source for the voltage detection circuit 22 and a power source for the load circuit 24.

The load circuit 24 is activated by using the output direct-current voltage of the LDO 21 and executes predetermined data processing and the like.

The communication antenna 20T performs communication by establishing electromagnetic coupling with a signal transmitting antenna, the illustration of which is omitted. Note that in the case where the power transmitting coil 900 and the signal transmitting antenna are the same, the communication antenna 20T performs near field communication by establishing electromagnetic coupling with the power transmitting coil 900. This near field communication is controlled by the near field communication IC 23 connected to the communication antenna 20T. The near field communication IC 23 and the load circuit 24 can communicate data with each other. On the basis of a result of data communication with the load circuit 24, the near field communication IC 23 controls the near field communication that uses the communication antenna 20T.

With the configuration described above, the wireless power receiving device 10 further performs the following control.

The resistive element R41 that serves as the impedance adjusting circuit is connected in parallel to both end portions of the power receiving coil 20P. According to this configuration, part of the current generated at a time when the power receiving coil 20P is coupled with the external magnetic field flows through the resistive element R41. Accordingly, compared with the configuration without the resistive element R41, the configuration with the resistive element R41 can suppress the voltage between two ends of the power receiving coil 20P (input voltage of the rectifying circuit), even at the same external magnetic field strength.

Therefore, the configuration including the resistive element R41 can expand a protectable range up to a higher range of the external magnetic field strength where the configuration not including the resistive element R41 cannot protect. Because of this, the wireless power receiving device 10 can increase withstand voltages of circuits that follow the rectifying circuit, that is, the power receiving alternating-current circuit and the power receiving direct-current circuit, for a higher external magnetic field strength. Accordingly, the wireless power receiving device 10 can realize more reliable overvoltage protection for the power receiving alternating-current circuit and the power receiving direct-current circuit.

On the basis of the smoothed voltage (output voltage of the smoothing circuit), the voltage detection circuit 22 generates a control signal for the switching element S62 and the switching element S64. Note that the voltage detection circuit 22 is activated by the output direct-current voltage of the LDO 21.

The voltage detection circuit 22 compares the smoothed voltage with a first voltage and generates the control signal on the basis of the result of comparison. When the smoothed voltage is less than the first voltage, the voltage detection circuit 22 generates a control signal to control the switching element S62 and the switching element S64 in such a way that the switching element S62 and the switching element S64 are turned off.

At the time when the switching element S62 and the switching element S64 are controlled to be turned off, the rectifying circuit executes the rectifying operation. Because of this, the rectified direct-current current is supplied to the smoothing circuit, and direct-current power of a predetermined voltage for the load circuit 24 is supplied.

When the smoothed voltage is greater than or equal to the first voltage, the voltage detection circuit 22 generates a control signal to control the switching element S62 and the switching element S64 in such a way that the switching element S62 and the switching element S64 are turned on. At the time when the switching element S62 and the switching element S64 are controlled to be turned on, the rectifying circuit stops the rectifying operation. Because of this, no current flows into the smoothing circuit, and the supply of the direct-current power to the load circuit 24 stops.

Here, the first voltage is set on the basis of the external magnetic field strength (size) that acts on the power receiving coil and the size of power of the load circuit (breakdown voltages of circuit components that constitute the load circuit).

More specifically, the first voltage is determined by an upper limit voltage up to which the power receiving direct-current circuit in the state where the resistive element R41 is connected thereto can be protected. Furthermore, the voltage in the state where the resistive element R41 is connected corresponds to the external magnetic field strength. Accordingly, the first voltage is set on the basis of the external magnetic field strength.

Further, the upper limit voltage of the power receiving direct-current circuit is determined by the power and the breakdown voltage of the power receiving direct-current circuit, particularly, the power of the load circuit 24 and the breakdown voltages of the circuit components that constitute the load circuit 24. Accordingly, the first voltage is set on the basis of the size of power of the load circuit (the breakdown voltages of the circuit components that constitute the load circuit).

By using the first voltage that is set in the manner described above, the foregoing receiving power shut-off circuit operates. Because of this, in the range of the external magnetic field strength within which no overvoltage is applied to the power receiving direct-current circuit, the wireless power receiving device 10 causes the rectifying circuit to execute the operation thereof and enables the supply of power of an appropriate voltage to the power receiving direct-current circuit including the load circuit 24.

On the other hand, in the range of the external magnetic field strength within which there is a possibility that overvoltage may be applied to the power receiving direct-current circuit, the wireless power receiving device 10 stops the operation of the rectifying circuit, stops the power supply to the power receiving direct-current circuit including the load circuit 24, and enables the protection of the power receiving direct-current circuit against the overvoltage.

As described above, by having the configuration of the present embodiment, using the impedance adjusting circuit, the wireless power receiving device 10 enables the suppression of the increase in the voltage between two ends of the power receiving coil 20P, and also enables the protection of the power receiving alternating-current circuit against overvoltage at the time of both executing and stopping the rectifying operation caused by the receiving power shut-off circuit. Furthermore, using the receiving power shut-off circuit, the wireless power receiving device 10 enables the supply of appropriate power to the power receiving direct-current circuit in the range where no overvoltage is applied to the power receiving direct-current circuit and enables the protection of the power receiving direct-current circuit against overvoltage in the range where overvoltage is applied to the power receiving direct-current circuit. Because of this, the wireless power receiving device 10 can expand the range of the external magnetic field strength within which power can be received appropriately and further realize appropriate overvoltage protection.

Furthermore, by including the impedance adjusting circuit and the receiving power shut-off circuit described above, the wireless power receiving device 10 can also have the following functions and effects. FIG. 3A is a diagram illustrating an exemplary displacement of the external magnetic field strength in the configuration of the present application, and FIG. 3B is a diagram illustrating an exemplary displacement of the external magnetic field strength in a comparative configuration (configuration in which the impedance adjusting circuit in the configuration of the present application is not included). FIG. 3A and FIG. 3B illustrate the cases where the external magnetic field strength is within the range of the magnetic field strength where the receiving power shut-off circuit operates in a configuration not including the impedance adjusting circuit. FIG. 3A and FIG. 3B illustrate envelopes of the magnetic field strength in the state where data communication is not performed (state where only power supply is performed).

First, in the comparative configuration, the receiving power shut-off circuit operates every time overvoltage is reached. Because of this, the current flowing through the power receiving coil 20P changes, and as illustrated in FIG. 3B, the envelopes of the external magnetic field strength change. These changes depend on the switching period of the switching element.

Such changes in the envelopes of the external magnetic field strength become noise in communication that uses these envelopes of the magnetic field strength. That is to say, the amplitude of current for communication of a communication device depends on the size of the external magnetic field. Accordingly, when the envelope changes, an unintended change in the amplitude of current for communication occurs. Therefore, there is a possibility that the communication device erroneously detects a change in the envelope as communication data.

However, by having the configuration of the disclosure of the present application (impedance adjusting circuit), as illustrated in FIG. 3A, the envelope of the external magnetic field strength becomes constant by suppressing the operation of the receiving power shut-off circuit until a predetermined magnetic field strength is reached. Accordingly, a change in the envelope is caused only by communication data, and the communication device can detect communication data more reliably.

As described above, by having the foregoing configuration, the wireless power receiving device 10 can execute and continue data communication more reliably in a predetermined range of the magnetic field strength (range that can be set by the impedance adjusting circuit) that is higher than that of the comparative configuration not including the impedance adjusting circuit (existing configuration). Because of this, compared with the comparative configuration not including the impedance adjusting circuit (existing configuration), the wireless power receiving device 10 enables the stable data communication while receiving power wirelessly.

Further, in the wireless power receiving device 10, the resistive element R41 that serves as the impedance adjusting circuit is connected closer to the power receiving coil 20P than the capacitor C32 that serves as a series resonant capacitor. Because of this, the current generated in the power receiving coil 20P directly flows through the resistive element R41, and thus effects of impedance adjusting are produced more effectively.

### Second Embodiment

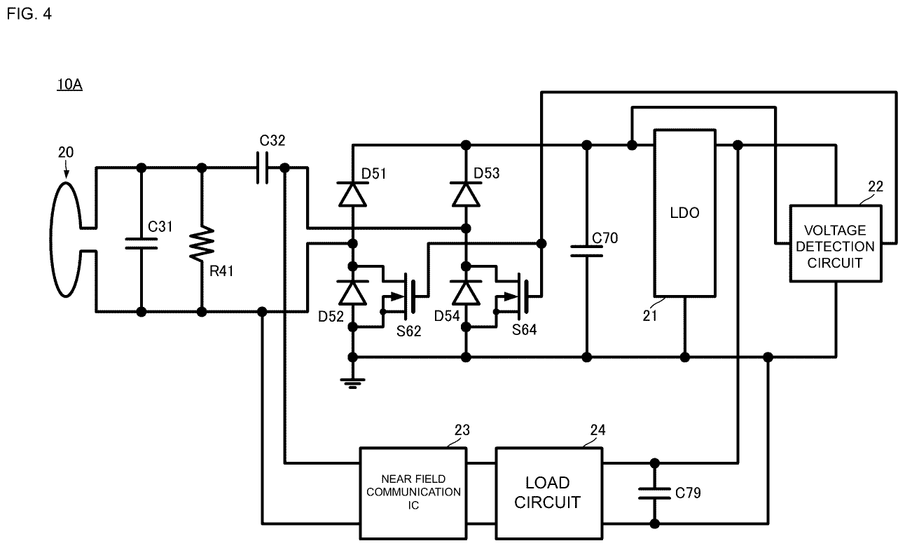

A wireless power receiving device according to the second embodiment of the present disclosure is now described with reference to the drawing. FIG. 4 is a circuit diagram illustrating an example of configuration of the wireless power receiving device according to the second embodiment.

As illustrated in FIG. 4, the wireless power receiving device 10A according to the second embodiment is different from the wireless power receiving device 10 according to the first embodiment in that a common coil 20 for power receiving and signal receiving is included. The remaining configuration of the wireless power receiving device 10A is similar to that of the wireless power receiving device 10, and the description regarding the similar part is omitted.

The wireless power receiving device 10A includes the coil 20. The other terminal of the capacitor C32 and the second end portion of the coil 20 are connected to the near field communication IC 23. In this configuration, the resonant frequency for power receiving and the resonant frequency for signal receiving are the same, and the power receiving resonant circuit doubles as the signal receiving resonant circuit.

According to the configuration described above, the wireless power receiving device 10A can produce functions and effects similar to those of the wireless power receiving device 10. Furthermore, the wireless power receiving device 10A uses the common coil 20 for power receiving and signal receiving, and thus enables the realization of a further reduction in size. Further, this configuration is more susceptible to the foregoing changes in the envelopes of the magnetic field strength at the time of power receiving. Accordingly, in the wireless power receiving device 10A, the functions and effects described above are more beneficial.

### Third Embodiment

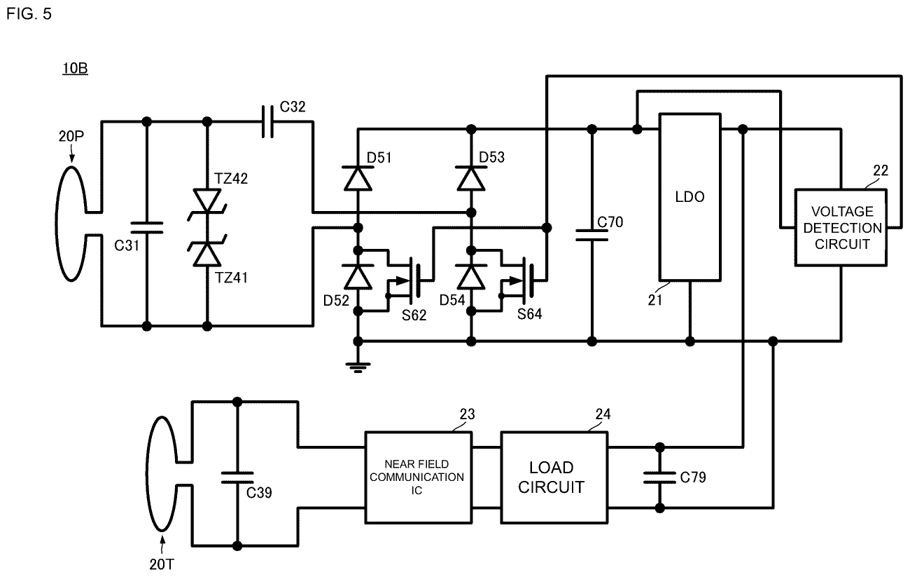

A wireless power receiving device according to the third embodiment of the present disclosure is now described with reference to the drawing. FIG. 5 is a circuit diagram illustrating an example of configuration of the wireless power receiving device according to the third embodiment.

As illustrated in FIG. 5, the wireless power receiving device 10B according to the third embodiment is different from the wireless power receiving device 10 according to the first embodiment in the configuration of the impedance adjusting circuit. The remaining configuration of the wireless power receiving device 10B is similar to that of the wireless power receiving device 10, and the description regarding the similar part is omitted.

The wireless power receiving device 10B includes, as the impedance adjusting circuit, a series circuit of a zener diode TZ41 and a zener diode TZ42. The cathode of the zener diode TZ41 is connected to the cathode of the zener diode TZ42. The anode of the zener diode TZ41 is connected to the second end portion of the power receiving coil 20P, and the anode of the zener diode TZ42 is connected to the first end portion of the power receiving coil 20P.

The zener voltages of the zener diode TZ41 and the zener diode TZ42 are set on the basis of a voltage at which no overvoltage is applied to the power receiving alternating-current circuit.

With this configuration, when the external magnetic field strength is low and the voltage is less than the zener voltages, regardless of the external magnetic field strength, no large current flows through the zener diode TZ41 and the zener diode TZ42. Accordingly, the wireless power receiving device 10B enables the maintaining of appropriate power receiving operation and the suppression of adverse impacts on communication characteristics.

Further, when the external magnetic field strength is high and the voltage is greater than or equal to the zener voltages, a large current flows through the zener diode TZ41 and the zener diode TZ42, and the voltage between two ends of the power receiving coil 20P decreases. Accordingly, the wireless power receiving device 10B enables the protection of the power receiving alternating-current circuit and the power receiving direct-current circuit. In this case, the communication antenna 20T is provided separately from the power receiving coil 20P, and this enables the suppression of adverse impacts on the communication characteristics.

### Fourth Embodiment

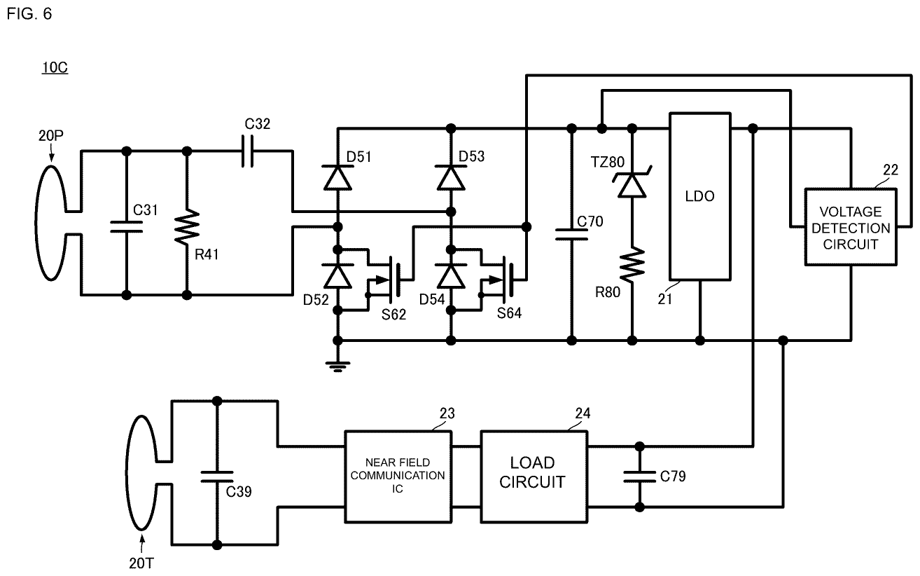

A wireless power receiving device according to the fourth embodiment of the present disclosure is now described with reference to the drawing. FIG. 6 is a circuit diagram illustrating an example of configuration of the wireless power receiving device according to the fourth embodiment.

As illustrated in FIG. 6, the wireless power receiving device 10C according to the fourth embodiment is different from the wireless power receiving device 10 according to the first embodiment in that an overvoltage protection circuit is added. The remaining configuration of the wireless power receiving device 10C is similar to that of the wireless power receiving device 10, and the description regarding the similar part is omitted.

The wireless power receiving device 10C includes a zener diode TZ80 and a resistive element R80. The zener diode TZ80 and the resistive element R80 are connected in series. Specifically, the anode of the zener diode TZ80 is connected to one terminal of the resistive element R80. The cathode of the zener diode TZ80 is connected between the input terminal of the LDO 21 and the node at which the smoothing circuit is connected to the Hi side wiring pattern. The other end terminal of the resistive element R80 is connected to the Low side wiring pattern. The zener diode TZ80 and the resistive element R80 described above constitute the “overvoltage protection circuit” of the present disclosure.

The zener voltage of the zener diode TZ80 is set to a voltage lower than the first voltage.

According to the configuration described above, the wireless power receiving device 10C enables the realization of overvoltage protection of the load circuit 24 in two stages. More specifically, the wireless power receiving device 10C performs overvoltage protection of the load circuit 24 at a predetermined voltage lower than the first voltage using the overvoltage protection circuit (the zener diode TZ80 and the resistive element R80). Because the overvoltage protection circuit does not cause any change in the external magnetic field strength, at this point, it becomes possible to realize the power receiving operation and the communication operation appropriately while protecting the load circuit 24. Furthermore, when the first voltage is reached, the wireless power receiving device 10C causes the receiving power shut-off circuit to operate and enables the overvoltage protection of the load circuit 24.

### Fifth Embodiment

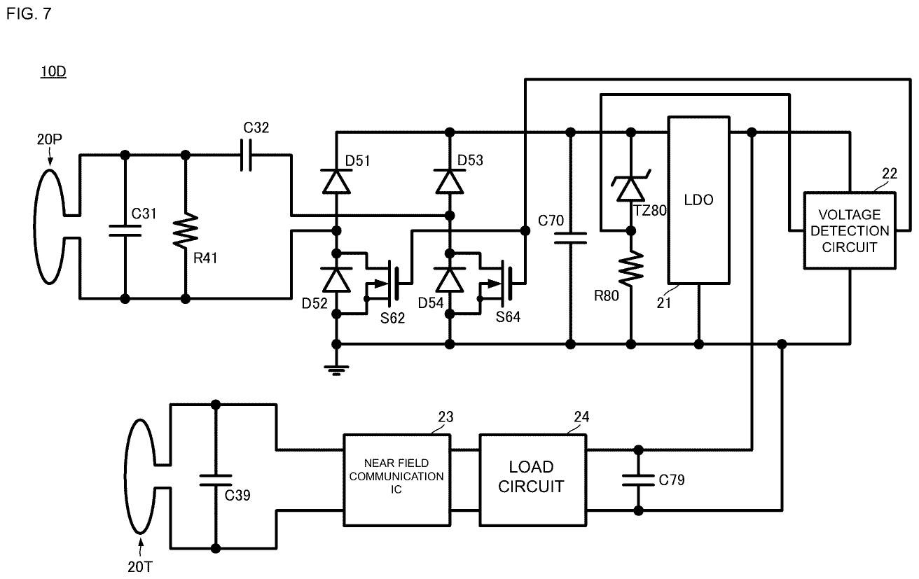

A wireless power receiving device according to the fifth embodiment of the present disclosure is now described with reference to the drawing. FIG. 7 is a circuit diagram illustrating an example of configuration of the wireless power receiving device according to the fifth embodiment.

As illustrated in FIG. 7, the wireless power receiving device 10D according to the fifth embodiment is different from the wireless power receiving device 10C according to the fourth embodiment in the detection voltage of the voltage detection circuit. The remaining configuration of the wireless power receiving device 10D is similar to that of the wireless power receiving device 10C, and the description regarding the similar part is omitted.

In the wireless power receiving device 10D, the detection voltage input terminal of the voltage detection circuit 22 is connected to a node between the zener diode TZ80 and the resistive element R80. Because of this, the voltage detection circuit 22 detects the voltage applied to the resistive element R80 at a time when a current flows through the resistive element R80, that is, at a time when the zener current flows through the zener diode TZ80.

When the voltage is such a low voltage that no zener current flows through the zener diode TZ80, the voltage detection circuit 22 detects this voltage and controls the switching element S62 and the switching element S64 in such a way that the switching element S62 and the switching element S64 are turned off (generates an off-control signal). In other words, when the overvoltage protection circuit is not in operation, the voltage detection circuit 22 controls the switching element S62 and the switching element S64 in such a way that the switching element S62 and the switching element S64 are turned off.

At a time when the zener current flows through the zener diode TZ80, the voltage detection circuit 22 detects this voltage and controls the switching element S62 and the switching element S64 in such a way that the switching element S62 and the switching element S64 are turned on (generates an on-control signal). In other words, when the overvoltage protection circuit is in operation, the voltage detection circuit 22 controls the switching element S62 and the switching element S64 in such a way that the switching element S62 and the switching element S64 are turned on.

As described above, the wireless power receiving device 10D enables the operation of the receiving power shut-off circuit in a manner that depends on the operation of the overvoltage protection circuit that uses the zener diode TZ80. Because of this, the wireless power receiving device 10D enables the protection of the zener diode TZ80 from overcurrent.

The configuration and control in each of the embodiments described above can be combined if appropriate, and functions and effects corresponding to each combination can be produced.

What is claimed is:

1. A wireless power receiving device comprising:
a power receiving circuit;
a load circuit electrically connected to the power receiving circuit; and
a power receiving coil electrically connected to the power receiving circuit, wherein
the power receiving circuit includes
an impedance adjusting circuit configured to adjust input impedance looking from the power receiving coil into a load circuit side,
a rectifying circuit configured to rectify an alternating-current current flowing through the power receiving coil,
a smoothing circuit electrically connected to the rectifying circuit, and
a receiving power shut-off circuit configured to switch between executing and stopping a rectifying operation of the rectifying circuit using a result of comparison between a smoothed voltage of the smoothing circuit and a predetermined first voltage,
the power receiving coil, the impedance adjusting circuit, and the rectifying circuit configure a power receiving alternating-current circuit,
the smoothing circuit and the load circuit configure a power receiving direct-current circuit,
the first voltage is set on a basis of size of an external magnetic field that acts on the power receiving coil and size of power of the load circuit,
the impedance adjusting circuit is configured to suppress an increase in a voltage between two ends of the power receiving coil,
the receiving power shut-off circuit is configured to
cause the rectifying circuit to execute the rectifying operation when the smoothed voltage is less than the first voltage, and
cause the rectifying circuit to stop the rectifying operation when the smoothed voltage is greater than or equal to the first voltage, and
the impedance adjusting circuit and the receiving power shut-off circuit protect the power receiving alternating-current circuit and the power receiving direct-current circuit from overvoltage.

2. The wireless power receiving device according to claim 1, wherein
the receiving power shut-off circuit is configured to protect the power receiving direct-current circuit from overvoltage by stopping the rectifying operation of the rectifying circuit,
the impedance adjusting circuit is configured to suppress the increase in the voltage between two ends of the power receiving coil and further protect the power receiving alternating-current circuit from overvoltage at time of both executing and stopping the rectifying operation caused by the receiving power shut-off circuit, and
regardless of the executing or stopping the rectifying operation caused by the receiving power shut-off circuit, both the power receiving alternating-current circuit and the power receiving direct-current circuit are protected.

3. The wireless power receiving device according to claim 1, wherein
the first voltage is set at an upper limit voltage, the upper limit voltage being a voltage up to which the power receiving direct-current circuit in a state where the impedance adjusting circuit is connected thereto is protectable by shutting off power receiving using the receiving power shut-off circuit.

4. The wireless power receiving device according to claim 1, further comprising:
a communication circuit; and
a communication antenna electrically connected to the communication circuit, wherein
the communication antenna and the power receiving coil are a same coil.

5. The wireless power receiving device according to claim 1, further comprising:
a communication circuit; and
a communication antenna electrically connected to the communication circuit, wherein
the communication antenna includes a coil that is different from the power receiving coil.

6. The wireless power receiving device according to claim 1, wherein
the impedance adjusting circuit includes a resistive element.

7. The wireless power receiving device according to claim 1, wherein
the impedance adjusting circuit includes a zener diode.

8. The wireless power receiving device according to claim 1, wherein
the impedance adjusting circuit includes two zener diodes that are connected in series in mutually opposite directions.

9. The wireless power receiving device according to claim 1, wherein
the receiving power shut-off circuit includes
a switching element connected in parallel to a rectifying element of the rectifying circuit.

10. The wireless power receiving device according to claim 1, further comprising:
an overvoltage protection circuit connected between the smoothing circuit and the load circuit, wherein
the overvoltage protection circuit includes
a zener diode connected in parallel to the smoothing circuit, the zener diode being configured to operate at a voltage lower than the first voltage.

11. The wireless power receiving device according to claim 10, wherein
the receiving power shut-off circuit is configured to operate based on a voltage of the overvoltage protection circuit.

12. The wireless power receiving device according to claim 1, further comprising:
a power receiving resonant circuit including the power receiving coil and a first resonant capacitor connected in parallel to the power receiving coil.

13. The wireless power receiving device according to claim 12, wherein
the power receiving resonant circuit includes a second resonant capacitor connected in series to the power receiving coil.

14. The wireless power receiving device according to claim 13, wherein
the impedance adjusting circuit is connected closer to the power receiving coil than the second resonant capacitor.

15. The wireless power receiving device according to claim 1, wherein
a frequency of the external magnetic field is 13.56 MHz.

16. The wireless power receiving device according to claim 1, wherein
a frequency of the external magnetic field is 6.78 MHz.

17. The wireless power receiving device according to claim 2, further comprising:
a communication circuit; and
a communication antenna electrically connected to the communication circuit, wherein
the communication antenna and the power receiving coil are a same coil.

18. The wireless power receiving device according to claim 2, further comprising:
a communication circuit; and
a communication antenna electrically connected to the communication circuit, wherein
the communication antenna includes a coil that is different from the power receiving coil.

19. The wireless power receiving device according to claim 2, wherein
the impedance adjusting circuit includes a resistive element.

20. The wireless power receiving device according to claim 2, wherein
the impedance adjusting circuit includes a zener diode.
